(19) United States
(12) Patent Application Publication
(10) Pub. No.: US 2011/0147302 A1
(43) Pub. Date: Jun. 23, 2011

(54) Oil/Water Separator

(75) Inventors: William Carr, Swanwick (GB); Sean Taylor, Peterlee (GB)

(73) Assignee: Conder Products Limited, Peterlee (GB)

(21) Appl. No.: 11/884,606

(22) PCT Filed: Feb. 17, 2006
(86) PCT No.: PCT/GB06/00580

§ 371 Date: Mar. 14, 2008

(30) Foreign Application Priority Data
Feb. 18, 2005 (GB) 0503368.3
Jul. 29, 2005 (GB) 0515634.4
Aug. 16, 2005 (GB) 0516782.0

(51) Int. Cl. B01D 21/26; B01D 17/00

(52) U.S. Cl. 210/512.1; 210/519; 210/521

(57) ABSTRACT

An oil/water separator includes an ingress (21,221) for an oil/water mixture and a coalescing means (16,116) through which the oil/water mixture passes to reach an oil retention chamber (17,217). Preferably, the coalescing means (16,116) is an open cell foam, such as reticulated polyurethane foam, and is provided in an annular configuration (16). In a preferred embodiment, the oil/water separator comprises a means for generating an oil/water mixture vortex positioned upstream of the coalescing means (16,116).

### TECHNICAL FIELD OF THE INVENTION

The present invention relates to the separation of immiscible liquids, and in particular to an improved means for separating oil from water which minimises tank volume requirements and results in more efficient separation, and applications thereof.

### BACKGROUND ART

Oil/water separators are used to protect receiving waters such as rivers, oceans, streams and other watercourses into which wastewater or treated effluents are discharged, from pollution by oil and other immiscible fluid contaminants. Such separators are commonly found in areas susceptible to oil spillages, such as roads, car parks and petrol station forecourts.

The term “oil” as used herein is intended to refer to an organic liquid which is immiscible with an aqueous liquid and when mixed therewith would tend to form a discontinuous droplet phase within the continuous aqueous phase. Furthermore, in the absence of surface active agents, the oil in such a mixture would upon standing over a period of time tend to separate to the surface of the aqueous fluid.

Typically, oil/water separators are “in-line” devices used to remove oils and greases (and sometimes solids) from industrial waste streams and storm water discharges. Usual modes of operation rely upon various physical or chemical separation methods, including gravity separation, filters, coagulation/flocculation, and flotation. However, the selected use of a particular separation process may be influenced by the properties of the oil in the oil/water mixture and other mixed-in contaminants or reagents e.g. detergents.

The separators of the known type under consideration here are designed to operate to either Class 1 or Class 2 criteria, as defined by the European Standards Body (CEN) testing procedure. Class 1 separators, which are designed to discharge water with an oil content of less than 5 mg/1, are commonly used where the levels of oil are likely to be fairly low, resulting, for example, only from minor accidental leakages from vehicles. Class 2 separators are designed to achieve oil concentrations of less than 100 mg/ml, and are more suitable where lower quality requirements are in place, for example where the released water will subsequently enter further treatment facilities before being discharged.

Typically, oil/water separators come in full retention and by-pass separator formats, both of which can be produced to conform to either Class 1 or Class 2 stringencies, as required. By-pass separators conventionally treat rainfall flows of up to 5 mm/hour. Flow rates below this level constitute 99% of all rainfall events. In the event of severe rainfall, resulting in flows which surpass this rate, stormwater, which is largely uncontaminated, overflows directly to the outlet and by-passes the separation system. Full retention systems are designed to cope with rainfall intensities of up to 50 mm/hour, and thus do not necessitate a by-pass facility. Such retention systems are used mainly in areas of high risk, for example in petrol station forecourts, where the levels of oil contamination are likely to be significant.

Many conventional oil/water separators incorporate oil retention chambers to contain the separation mixture which is an oil/water fluid mixture and to allow the oil and water to separate naturally, via gravitational forces. These oil retention chambers are typically large capacity tanks in which the oil and water mixture is retained for a sufficient time in a relatively undisturbed state, such as that described in U.S. Pat. No. 6,824,696. In such oil retention chambers, the oil and water fluid mixture is typically left to stand, permitting both settling of insoluble particulates and partition of separable fluid, to allow the less dense droplets of oil present within the bulk of the mixture to rise to the fluid surface. In some cases, water from the bottom of the oil retention chamber, from which the majority of oil has already been extracted, is then passed through a large area of coalescing media.

Within the bulk of the oil/water fluid mixture, small droplets of oil will remain after settling of the mixture. These smaller droplets do not have sufficiently low density to cause them to settle at the surface of the oil and water fluid mixture during the settling stage. It is these smaller droplets that the coalescing media in the form of coalescing filters are intended to extract. Conventionally, cleaner water from the bottom of the chamber is passed through a coalescing filter to remove this further remaining oil. The coalescing filter causes smaller droplets of oil to agglomerate until they reach a sufficient size and buoyancy to rise to the surface of the mixture.

Once oil has accumulated as a top layer of the fluid surface, separation is typically carried out by extracting the clean water from the bottom of the separation chamber or by skimming the oil from the top of the fluid surface.

An inherent disadvantage of this type of separation system is the need for a large capacity tank to be provided which allows the oil and water mixture to be held in a relatively undisturbed state while oil droplets rise to the surface. Typically, the capacity of the tank is related to the residence time allowed and thus large capacity tanks are required when a high throughput of fluid is desirable. Furthermore, oil-coated water droplets may remain in the fluid after filtration due to their more dense nature. These oil-coated droplets do not have a high-level of attraction to the standard coalescing media and tend to remain in the fluid.

A liquid purification system is described in U.S. Pat. No. 5,443,724 for use in treating a liquid constituted by an aqueous continuous phase and a less dense discontinuous phase, which system includes at least one coalescing element or assembly for use in combination with at least one separation assembly the former being superposed upon the latter. This system is not designed for installation underground and requires access for maintenance. Furthermore it requires in stacked combination a coalescing element and a separation assembly which physically promotes separation of the liquids e.g. a PTFE-coated metal mesh.

In U.S. Pat. No. 4,554,074, a fluid separator for immiscible fluids is provided which converts the initially turbulent, high-velocity fluid into substantially laminar low-velocity fluid within channels, in order to facilitate the phase separation of the mixture by gravitational means. It is thus conventional practice within the field of oil/water separators to minimise disturbance to the separation mixture and to promote a relatively low velocity for the passage of the fluid through the separation system.

### DISCLOSURE OF THE INVENTION

The present invention identifies certain drawbacks of conventional oil/water separators and proposes an improved oil/water separator which obviates or mitigates one or more of the limitations of the conventional separators and generally provides a separator of relatively simple and compact design offering a small footprint, and which is easy to operate and maintain.

Further advantages of the invention will become apparent from reading the following description.

In particular the invention takes account of the observation that when comparing droplet size in relation to separation times for mixed oil/water systems, a large droplet (say 100 micron diameter) will separate to the surface of a body of water significantly faster than a small droplet (say 20 micron diameter) under comparable conditions. Residence times in a typical separator (i.e. duration of oil-contaminated fluid passage between separator inlet and outlet) to be treated sometimes may be insufficient to allow small oil droplets to separate. Accordingly, this leads to apparent inefficiencies in the separator in that the output form the separator still contains oil droplets. The invention addresses this problem by introducing means for promoting coalescence of oil droplets in the fluid to be treated in the separator at the input side of the separator before any oil-separation in the conventional way occurs to thereby improve the opportunity for separation of oil droplets within the separator and thereby reduce carry-over of entrained oil droplets in the separator outlet.

Furthermore, the invention also provides for enhanced coalescence by provision of means for influencing the flow of the oil/water mixture to be separated prior to introduction to the means for coalescing the oil.

According to a first aspect of the invention, there is provided an oil/water separator having an oil separation chamber, characterised by the provision of a near-inlet oil-coalescing means for initial treatment of an oil-contaminated aqueous fluid before it enters the oil-separation chamber for separation of oil from the fluid. The arrangement of an oil-coalescing means in the contaminated fluid inlet path promotes the formation of larger oil droplets which are more easily separated in the separation chamber prior to discharge therefrom.

Such an oil/water separator may comprise a means for permitting ingress for an oil/water mixture, and proximate thereto an oil-coalescing means configured to contact an oil/water mixture introduced via said means for ingress.

The means for ingress for an oil/water mixture may be configured to receive the mixture as a flow under gravity. Alternatively the flow may be pumped.

The invention is further characterised by the presence of means for inducing controlled flow in the oil/water mixture received from the means for ingress before it is introduced to the coalescing means. The controlled flow may be achieved by contact with static surfaces configured to direct flow into the coalescing means, e.g. baffles or weirs, or contoured surfaces defining a reducing volume flow path to drain. Ideally, an accelerated flow is achieved by vortex-generating means providing a helical path to drain accelerated fluid flow into the coalescing means.

In a typical separator design having an oil retention chamber, the improvement according to the invention provides the oil-coalescing means positioned upstream of the oil retention chamber.

Providing the coalescing means at a position in the oil/water separator whereby the oil and water mixture readily comes into contact with the coalescing means before oil has been removed from the mixture, ensures that the maximum amount of oil is brought into contact with the coalescing means. The inventors have surprisingly found that this advantageously results in a greatly improved coalescence effect, and enhanced performance efficiency for the separator. Furthermore, the coalescing means can be a relatively small component of the overall separator system.

The oil-coalescing means may be formed from an oleophilic or hydrophobic material, which may be a synthetic polymer-based or resin material.

The oil-coalescing material may be formed from fibres, strands or mesh or a foraminated material. The design thereof may be selected to maximise available surface area within a given volume of space, e.g. by provision of a pleated or undulating surface configuration.

Preferably the oil coalescing means is a coalescing filter which acts to retard oil flow but does not significantly inhibit flow of aqueous fluids.

Preferably, the coalescing filter is formed of an open-cell foam.

Open-cell foams are known in the art to perform as high-efficiency coalescing filters, however any other appropriate material can be used.

Preferably, the open-cell foam is a foam plastics material, especially a reticulated polyurethane foam.

In particular, a preferred reticulated polyurethane foam is a reticulated polyether-polyurethane foam.

The form of the coalescing means may vary but one form would be arranged around the axis of a flow path intended for oil/water mixture to be separated, in a configuration permitting contact, in use, with the oil/water mixture. Thus, the oil-coalescing means may have a tubular form permitting flow-through of oil/water mixture.

In one preferred form, the oil coalescing means is provided as a closed end sleeve which is at least in part freely permeable to water. This shape maximises the area for coalescing the oil resulting in high velocity flow-through of the oil/water mixture.

More preferably, the oil coalescing means is provided in an annular configuration around at least part of the length of a closed end sleeve or sock.

The annular configuration of the coalescing means advantageously allows all of the oil/water mixture to flow through the coalescing means at maximum velocity as well as ensuring that oil droplets released from the coalescing means are not trapped by the coalescing means, and can rise unhindered to the surface of the fluid.

Optionally, the oil/water separator further comprises a sedimentation chamber.

Optionally, the oil/water separator further comprises an ante chamber provided upstream of the coalescing means. The oil/water ingress accesses the ante chamber in that variation.

When the oil/water separator comprises a sedimentation chamber (or other sedimentation means) and an ante chamber, the sedimentation chamber (or other sedimentation means) is preferably located upstream of the ante chamber.

Optionally, the coalescing means is provided at the inlet to the oil retention chamber.

Preferably, the oil/water separator comprises a coalescing chamber in which the oil coalescing means is provided.

Optionally, when the oil/water separator comprises a coalescing chamber and an oil retention chamber, the oil retention chamber adjoins the coalescing chamber.

Optionally, the oil/water separator comprises a sedimentation chamber and a coalescing chamber, the sedimentation chamber being located upstream of the coalescing chamber.

According to a second aspect of the invention there is provided an improved oil/water separator comprising an ingress for an oil/water mixture and an oil coalescing means through which the oil/water mixture passes to reach an oil retention chamber; wherein a means for generating an oil/water mixture vortex is provided upstream of the oil coalescing means.

Preferably the means for generating an oil/water mixture vortex is provided above coalescing means. The vortex generating means may be superposed upon the coalescing means. The vortex generating means may be provided in one chamber contiguous with a lower chamber in which the coalescing means is provided to take advantage of the additional effect of gravity upon flow of oil/water mixture therethrough from the upper chamber to the lower chamber.

Providing the means for generating an oil/water mixture vortex in an upper chamber ensures that all of the oil and water mixture is pulled down into the coalescing chamber.

Optionally, the walls of the upper chamber are configured to form the means for generating an oil/water mixture vortex.

The means for generating an oil/water mixture vortex causes the oil-water mixture to swirl into a vortex cone or cyclone and is drawn down into the coalescing chamber which itself comprises the coalescing means. Droplets of oil within the water are then thrown against the inside face of the oil-coalescing means. This relatively violent fluid action causes the oil droplets to coalesce more readily, especially partially, emulsified oily-water droplets which burst, into oil droplets which are larger than those released from non-cyclone fed coalescing filters. These larger droplets have sufficient buoyancy when released from the outer surface of the coalescing means into the oil retention chamber to float to the water surface even against a downward flow of water. This allows the velocity of flow of water through the coalescing means and the separator to be much higher and therefore the retention time to be much less and the overall dimensions of the separator to be much smaller than conventional designs.

Advantageously, the means for generating an oil/water mixture vortex is configured to promote the direction of both oil and water phases of the mixture towards the coalescing means. This ensures that the maximum amount of oil comes into contact with the coalescing means. In addition, the generation of a vortex ensures that the mixture is propelled against the coalescing means with increased velocity. This has the added advantage that any oil-coated bubbles present within the mixture, come into contact with the coalescing means with sufficient velocity to burst the bubbles upon impact. This means that minute particles of oil, previously unseparated by conventional separation systems, can be efficiently extracted from water using the separator of the present invention.

Preferably the vortex-generating means comprises surfaces configured to define a helical flow path.

Optionally, the vortex-generating means comprises a hollow bodied receptacle provided with surfaces configured to define a helical flow path.

Another option is that the vortex-generating means comprises a funnel or conical tube arranged in the intended flow path of oil/water mixture, and shaped such that the cross-sectional area across the flow path reduces in the direction of bulk flow, and the surfaces contacted by the oil/water mixture direct its flow into a vortex.

Preferably, in use, the oil/water mixture flows through the vortex-generating means into the coalescing chamber. The oil/water mixture passes through the coalescing means provided therein. Agglomeration of oil droplets occurs at the coalescing means so that when the mixture is released into the oil retention chamber, the large oil droplets rise to the fluid surface.

### BRIEF DESCRIPTION OF THE DRAWINGS

A preferred embodiment of the invention will now be described with reference to the accompanying drawings in which:

FIG. 1 illustrates a side cross-sectional view of an oil/water separation system according to an embodiment of the invention;

FIG. 2 illustrates a side cross-sectional view of an oil/water separation system according to an alternative embodiment of the invention; and

FIG. 3 illustrates an embodiment of a vortex-generating device for use in a separation system according to of the invention.

### MODES FOR CARRYING OUT THE INVENTION

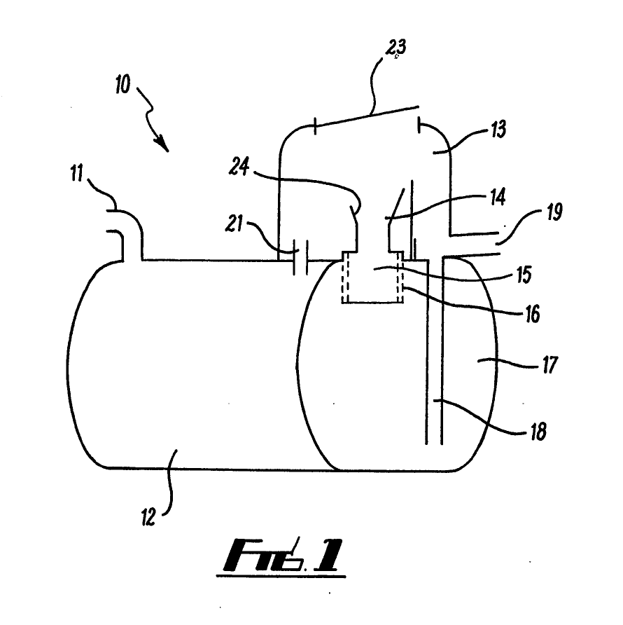

Referring firstly to FIG. 1, the drawing shows an oil/water separator generally depicted at 10. An access hatch into the system is indicated at 23. A sedimentation inflow pipe 11 provides for feed of oil/water mixture to be separated to be introduced to the system, together with any solid matter therein into the separation system 10, to be received initially in a sedimentation chamber 12, wherein solid contaminants present in the fluid are allowed to settle under gravity to the bottom of the chamber. This sedimentation chamber 12 operates on a simple decant mechanism, and when the fluid in the sedimentation chamber rises to a sufficient level, it will flow into a further chamber 13 arranged at a higher level through an ingress pipe 21. This upper chamber 13 is a compact ante chamber comprising a vortex-generating means 14 therein which also provides for drainage outflow of the fluid from ante chamber 13 into a coalescing chamber 15 situated at a lower level. The vortex-generating means 14 encourages development of an internal fluid vortex within the upper chamber 13 as the oily water flows down into the lower coalescing chamber. This has a number of effects including ensuring that the velocity of the fluid through the system is increased, which implies a shorter retention time, and thus allows the separation system to be provided in a more compact format than for conventional systems. The reduced physical size of the separator advantageously results in reduced manufacturing, transport and installation costs.

In this depicted embodiment, the vortex generating means 14 comprises a hollow-bodied helical receptacle through which the fluid passes. The receptacle comprises a contact surface 24 developing a downwardly progressing helical flow path of reducing diameter which exits into the coalescing chamber 15. The coalescing chamber 15 comprises peripheral coalescing means arranged within the chamber and defining at least in part a permeable contact flow path with respect to the fluid containing oil to be coalesced. In the depicted embodiment, the coalescing means is in the form of a filter media sock 16, (which optionally may have the form of a closed end sleeve) where the filter media is provided in an annular configuration at the end of the vortex, such that all of the water to have oil removed passes through the filter media sock 16. Here, the filter media is an open-cell foam, such as reticulated polyether polyurethane foam.

The performance of the vortex-generating means in combination with the coalescing means is such that the induced vortex serves to direct both the oil and water phases towards the peripheral filter media sock 16. The vortex additionally increases the momentum of the mixture, such that it is drawn towards the filter media sock 16 with increasing velocity in a cyclone formation.

Thus whilst the bulk drain flow is generally accelerating downwards, the induced vortex imparts an outwardly directed radial velocity component to the fluid.

The effect of this increased velocity in a radial direction is that small bubbles coated in oil impact the internal surface of the filter media sock 16 by centrifugal forces, causing them to burst. Thus, the oil is allowed to coalesce when travelling through the filter media sock 16 and larger droplets of oil are released from the outer surface of the filter media sock into the oil retention chamber 17. This ensures that oil droplets are free to rise to the surface of the fluid in the oil retention chamber and are not inhibited by the filter media.

The oil and water mixture entering the ante chamber 13 via ingress 21, rises and accesses the flow surfaces 24 of the vortex-generating means 14 and as it drains therethrough swirls into a vortex, within the vortex-generating means 14. The high energy centrifugal forces generated in the vortex-generating means forces the oil and water to travel through the filter media sock 16 in the coalescing chamber 15, which causes the oil to agglomerate and to form larger droplets of oil which rise to the surface of the mixture in the subsequent oil retention chamber 17. Clean water is removed from the bottom of the oil retention chamber 17 via a dip pipe 18 which siphons clean water from the lower area of the oil retention chamber to the separation outlet 19.

In use, during the separation procedure, oil and water mixtures, such as the run-off from a garage forecourt, enters the system via a sedimentation inflow pipe 11, which draws the fluid into the sedimentation chamber 12. The fluid then settles in this sedimentation chamber 12, with solid contaminants sinking to the surface of the chamber. Once the fluid within the sedimentation chamber 12 reaches a certain level, it will overflow into the adjoining upper chamber 13 via a pipe 21, leaving any sediment or solid contaminants at the bottom of the sedimentation chamber 12.

Whilst a sedimentation chamber 12 is provided at the beginning of this illustrative embodiment of the system, it will be understood that such a chamber can be provided at alternative positions along the length of the system. Furthermore, a sedimentation chamber 12 will not always be provided with the system, but is a useful addition to the system where solid contaminants are likely to be present in the separation mixture, for example, at car-wash stations. Where a sedimentation chamber is not present, fluid is drawn directly from the source into the upper chamber 13 via an inlet pipe. An alternative to a sedimentation chamber, which may be suitable for some applications, would be to provide a preliminary particle screening device such as a drain grating.

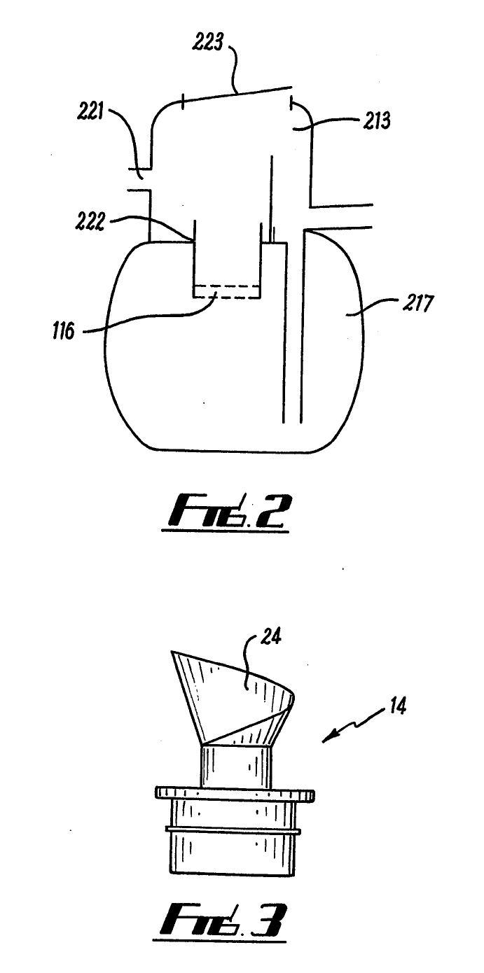

An alternative embodiment of the invention can be envisaged, which is illustrated in FIG. 2. In this embodiment, the oil and water fluid mixture is drawn directly into an upper chamber 213 via an ingress pipe, depicted at 221. An access shaft into the system is indicated at 223. From the upper chamber 213, the mixture passes through a skim pipe 222 towards a coalescing means. In the depicted embodiment, the coalescing means is provided as a flat planar configuration of filter media 116 at the lower end of the skim pipe 222. The oil and water mixture is thus pulled through the skim pipe 222 and towards the coalescing means by gravitational force. The oil is allowed to coalesce within the filter media 116 and larger droplets of oil are released from the lower surface of the filter media 116 into an oil retention chamber 217 where they rise to the surface. The lower level of oil-free water can then be siphoned off as previously described.

FIG. 3 illustrates a vortex-generating means, generally depicted at 14 according to an embodiment of the invention. This device comprises a shaped swirl pipe having an upwardly-oriented flared inlet and reducing diameter thereafter to form a substantially frusto-conical funnel (at least at the upper end). The funnel is positioned such that the oil/water mixture will enter at the widest point, and is optionally cut-away, with one sidewall surface of the funnel extending higher than a opposite surface, so that the oil/water mixture entering the vortex-generating means contacts the inner surface of the funnel and is preferentially deflected into a curved flow path. This causes the mixture to swirl into a cyclonic formation within the device, before coming into contact with a coalescing means. The person skilled in the art will understand that the angles of the funnel inner surface 24 are important in affecting the flow and development of a vortex, but there is a range of angles available which would be appropriate to produce a vortex which can be calculated taking into account other factors as the predicted flow rates and volumes of fluids to be treated. A design suitable for the production of a fluid vortex can readily be made and optimised with minimal trial and error. The vortex-generating means may be provided as an independent replaceable device to be located within an upper chamber of the separator, or may itself be formed as an integral part of an upper chamber, from which the fluid flows towards the coalescing means.

It will be evident that various modifications and improvements could be made to the above-described apparatus and methods within the scope of the invention. For example, the above description is written in the context of a by-pass separator for the purposes of illustration of performance of the invention. However, the methods and apparatus apply equally to full retention separator types. Thus the invention in its widest scope contemplates full retention and bypass separators. Furthermore, different types of coalescing means are envisaged for use with the described system.

Further modifications may be made without departing from the scope of the invention herein intended.

### INDUSTRIAL APPLICABILITY

The invention finds utility in environmental protection and remediation, water and wastewater treatment systems, in effluent treatments and design of plant for recovery or storage of water contaminated with oil or the like floating fluid by-products of industrial processes, surface water drainage systems, and in the design of highway- and hard-standing surface-drainage systems.

1. An oil/water separator for use in a drainage system comprising means for ingress of an oil/water mixture to be separated and an oil-retention chamber wherein the separator comprises an oil-coalescing means positioned upstream from the oil retention chamber and proximate to the means for ingress of an oil/water mixture, and in that flow-control means is provided between the ingress and the oil-coalescing means.

2. A separator as claimed in claim 1, wherein the oil coalescing means is a coalescing filter.

3. A separator as claimed claim 2, wherein the coalescing filter is formed of an open-cell foam.

4. A separator as claimed claim 3, wherein the open-cell foam is reticulated polyurethane foam.

5. A separator as claimed in claim 4, wherein the reticulated polyurethane foam is a reticulated polyether polyurethane foam.

6. A separator as claimed in claim 1, wherein the oil coalescing means is provided as a closed end sleeve.

7. A separator as claimed in claim 1, wherein the oil coalescing means is provided in an annular configuration along at least part of a closed end sleeve.

8. A separator as claimed in claim 1, wherein it further comprises a sedimentation chamber.

9. A separator as claimed in claim 1, wherein an ante chamber is provided upstream of the coalescing means, and said means for ingress of oil/water mixture accesses said ante chamber for introducing oil/water mixture to be separated.

10. A separator as claimed in claim 9, wherein the sedimentation chamber is located upstream of the ante chamber.

11. A separator as claimed in claim 1, wherein the coalescing means is provided at an inlet to the oil retention chamber.

12. A separator as claimed in claim 1, comprising a coalescing chamber in which the oil coalescing means is provided.

13. A separator as claimed in claim 12, wherein the oil retention chamber is provided adjoining the coalescing chamber.

14. A separator as claimed in claim 12 wherein the sedimentation chamber is located before the coalescing chamber.

15. A separator as claimed in claim 1, wherein the flow control means comprises means for generating an oil/water mixture vortex provided upstream of the oil coalescing means.

16. A separator as claimed in claim 15 wherein the means for generating an oil/water mixture vortex is provided in the ante chamber.

17. A separator as claimed in claim 16 wherein the ante chamber is configured to form the means for generating an oil/water mixture vortex.

18. A separator as claimed in claim 15, wherein the means for generating an oil/water mixture vortex comprises a helical device.

19. A separator as claimed in claim 15, wherein the means for generating an oil/water mixture vortex comprises a hollow helical receptacle.

20. A separator as claimed in claim 15, wherein the means for generating an oil/water mixture vortex comprises a conical tube shaped to guide the oil/water mixture into a vortex.

21. An oil/water separator comprising an oil coalescing means wherein means for generating an oil/water mixture vortex is provided upstream of the oil coalescing means.

22. A separator according to claim 21, wherein the means for generating an oil/water mixture vortex comprises a shaped swirl pipe having an upwardly-oriented flared inlet portion to form a substantially frusto-conical funnel providing in use for vortex drain flow directly into the oil coalescing means.

23. A separator according to claim 21, wherein the coalescing means comprises an open-cell foam, such as reticulated polyether polyurethane foam.

24. An oil/water coalescing device comprising in combination, a hollow bodied receptacle provided with surfaces configured to define a helical flow path, and a filter sock comprising an open cell foam, said sock being configured to receive flow from the helical flow path.

25. (canceled)
